(19) United States
(12) Patent Application Publication
(10) Pub. No.: US 2011/0226908 A1
(43) Pub. Date: Sep. 22, 2011

(54) Encased Square Wing

(76) Inventor: Luis Enrique Lopez Davila, Tampico (MX)

(21) Appl. No.: 12/988,358

(22) PCT Filed: Dec. 2, 2009
(86) PCT No.: PCT/MX2009/000129

§ 371 Date: Oct. 18, 2010

(30) Foreign Application Priority Data
Dec. 5, 2008 (MX) MX/A/2008/015544

(51) Int. Cl. B64C 39/06; B64C 23/06; B63B 1/00; B62D 35/00

(52) U.S. Cl. 244/199.4; 244/34 A; 114/271; 296/180.1

(57) ABSTRACT

The invention relates to an aerodynamic wing in the shape of a tubed perfect square, the vertical stabilizers and air brake being built into the structure thereof, characterized in that said wing reduces induced drag and increases the efficiency of aircraft in flight.

### SUMMARY OF THE INVENTION

The invention relates to an aerodynamic wing for aerial, aerospace, maritime and land use, specifically but not exclusively coupled to a structure, fuselage or craft.

### BACKGROUND

At present, conventional so-called planar wing models have not been successful in reducing induced drag originating at the wing tip, reducing aerodynamic efficiency in climbing configuration. As summarized by Dr. I. Kroo of Stanford University in his essay entitled “Nonplanar wing concepts for increased aircraft efficiency”, nonplanar wings offer the possibility of reduced drag compared with planar wings of the same span and lift.

The drag vortex originating at the wing tips of commercial aircraft accounts for a considerable proportion of the aircraft's cruise drag (typically 40%). It is for this reason that concepts leading to a reduction of induced drag (originating at the wing tip) can have a considerable effect on fuel consumption, the hundreds of millions of dollars airlines spend each year on fuel, and the environmental impact thereof.

The drag vortex is even greater at low speeds, where the drag vortex accounts for 80% to 90% of the drag of an aircraft climbing under critical take-off conditions.

The development of this aerodynamic wing, sought to be protected by means of this application, was undertaken with a view to increasing aircraft efficiency by reducing one of the four main forces that act on an aircraft.

The shape of the wing according to the invention comprises two components for reducing parasitic drag, while the vertical stabilizers are built into the structure thereof, thus achieving the main purpose of the invention, which is to reduce induced drag.

Said wing also enables the use of a canard, specifically located on the nose of the fuselage of a given aircraft.

### BRIEF DESCRIPTION OF THE FIGURES

FIG. 1 is a side view of the aircraft and the wing in the shape of a tubed perfect square.

FIG. 2 is a front view of the aircraft, showing the position of the vertical stabilizers as well as the airflow fins.

FIG. 3 is a top aerial view of the aircraft.

FIG. 4 is a front view of the location of the air brakes.

FIG. 5 is a profile view of the aircraft, showing the wings in the suggested position, offering maximum efficiency.

FIG. 6 shows a perfect square with two of the tip vertices thereof marked.

FIG. 7 shows the perfect square with two of the tip vertices joined to form a tube.

FIG. 8 shows the perfect square defining a circular duct, fully aligned according to two of its tip vertices.

FIG. 9 shows a vertical section of the wing, in which the aerodynamic profile can be seen.

FIG. 10 shows a use of the invention in the inverted form thereof.

FIG. 11 shows the vertical section of the inverted form of the wing.

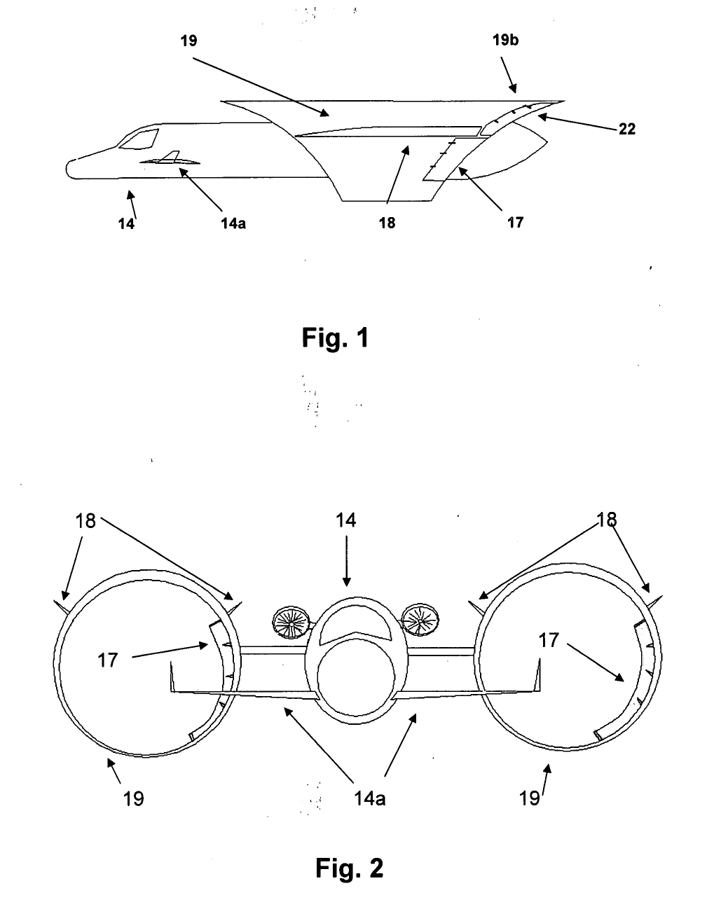

The invention relates to an aerodynamic wing for aerial, aerospace, maritime and land use, specifically but not exclusively coupled to a structure, fuselage or craft.

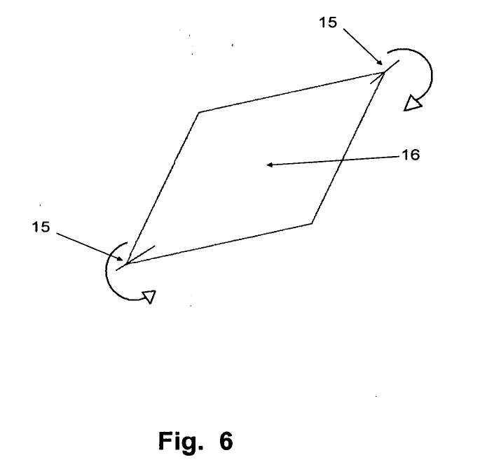

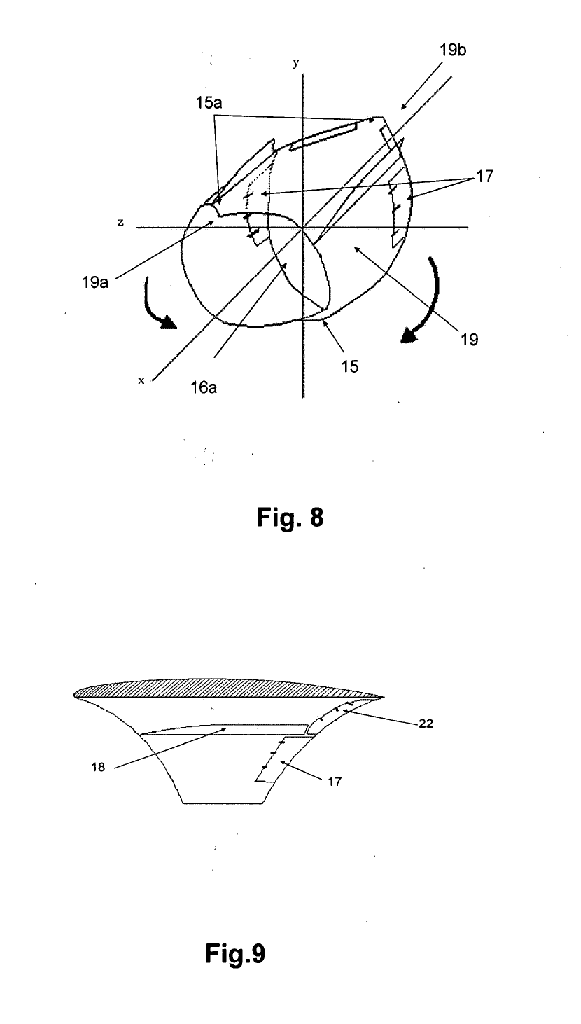

The present invention relates to a wing (19) made up of a perfect square (16) (FIG. 6) joined by two of the tip vertices (15) thereof such as to define a duct (16a), in which the remaining two vertices (15a) are aligned with the longitudinal axis of the wing (X), the vertices (15a) aligned with the longitudinal axis of the wing forming the top portion of the wing, the vertical stabilizers (17) being built into the structure of the wing and forming the rear portion (19b) thereof as shown in FIG. 8.

### DETAILED DESCRIPTION OF THE INVENTION

The aerodynamic wing (19) is made in the shape of a tubed (16a) perfect square (16) joined by two of the angle vertices (15) thereof such as to define a duct, the vertical stabilizers (17) being built into the lateral portion of the wing, referred to as the rear portion (19b) as shown in FIG. 8.

Two airflow distribution fins (18) are provided on the top surface of the wing, reducing the total aerodynamic lift surface.

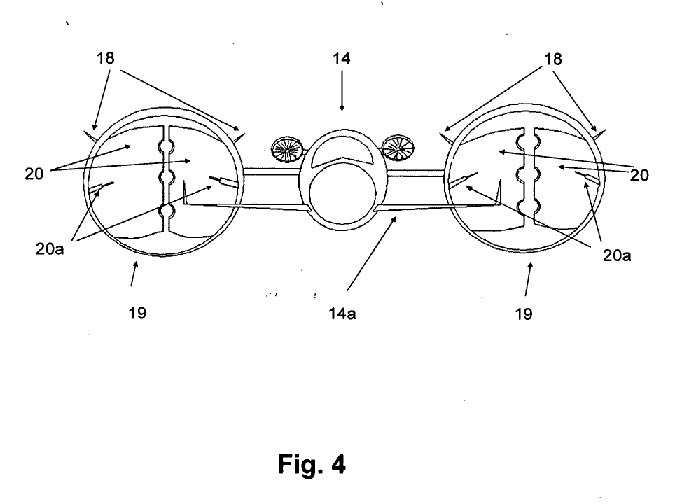

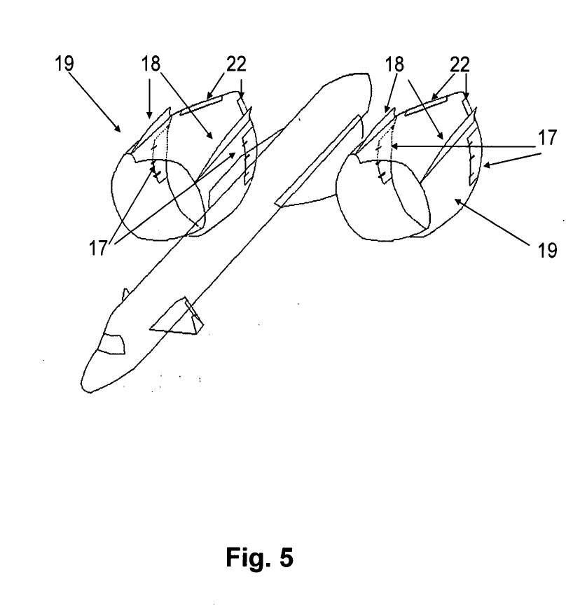

The air brake surfaces (20) are built into the duct (16a) of the aerodynamic wing (19) (FIG. 8). Said surfaces are operated by hydraulic actuators (20a) (FIG. 4) and, in the fully extended position thereof, form an air brake surface (20) which blocks the airflow in the inner portion of the structure of the aerodynamic wing (19), causing increased drag for forward movement.

The aerodynamic wing (19) in the shape of a tubed perfect square is characterized in that it offers reduced air drag, with positive resultant force when the aerodynamic form is the top portion thereof.

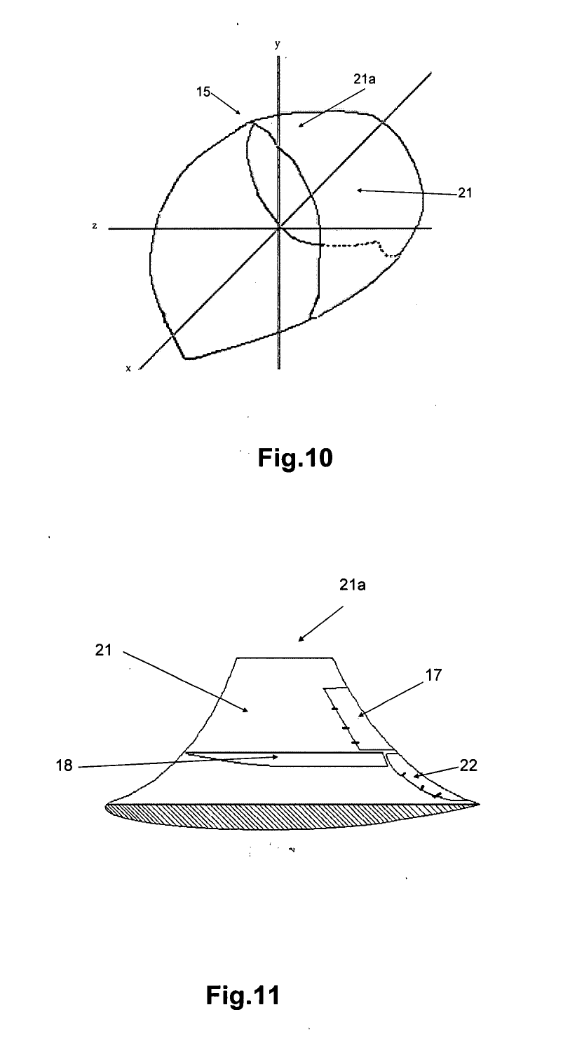

In the inverted form (21) of the wing, when the perfect square is joined by two of its tip vertices (15) and said join is at the top, referred to as the top portion (21a), the resultant aerodynamic force is negative, making said wing suitable for land or maritime uses, as shown in FIG. 10 and FIG. 11.

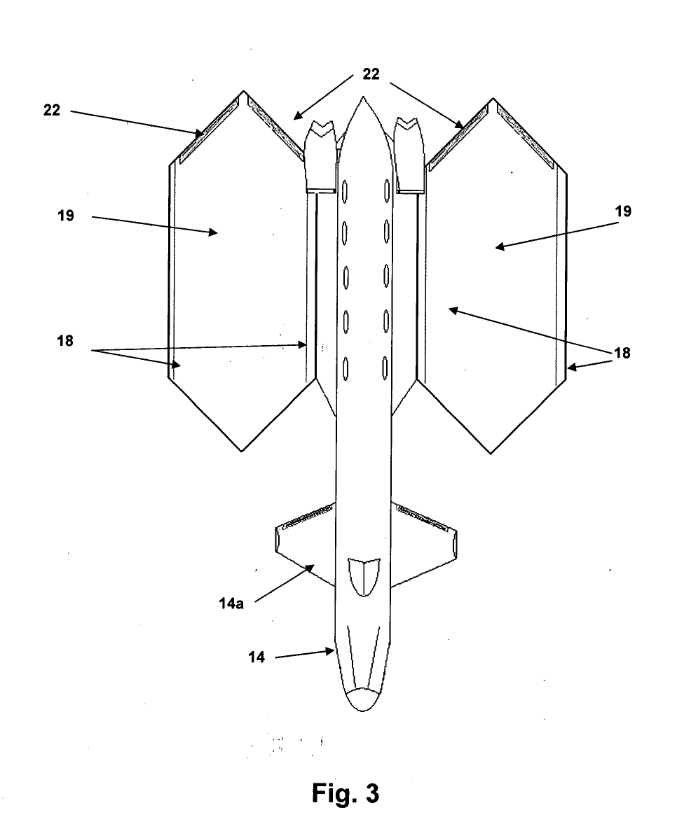

The aircraft fuselage (14) is characterized in that it includes a canard (14a) as an elevator aileron, said use providing maximum efficiency for aircraft at minimum control speed and at high speed (FIG. 3).

The flight control ailerons (22) can be seen positioned on the rear and top portions of the wing (19) in FIG. 3.

The aim of the invention is to overcome the disadvantages of earlier annular wings.

The wing according to the present invention is characterized mainly in that the wing (19) is made up of a perfect square (16) (FIG. 6) joined by two of the tip vertices (15) thereof such as to define a duct (16a), in which the remaining two vertices (15a) are aligned with the longitudinal axis of the wing (X), the vertices (15a) aligned with the longitudinal axis of the wing forming the top portion of the wing, the vertical stabilizers (17) being built into the structure of the wing and forming the rear portion (19b) thereof as shown in FIG. 8.

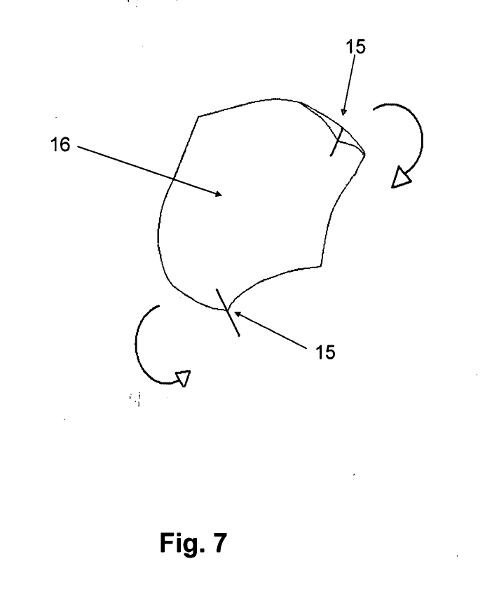

The term tubed perfect square (FIG. 6 and FIG. 7) is used to describe a cross-section of the annular wing, which forms a circle in the front or perspective view thereof (FIG. 2).

The join between the two vertices (15) aligned by the axis thereof will always be centered on the vertical axis (Y) of the structure of the wing (19) (FIG. 8), forming the bottom portion thereof.

The delta shape of the front portion (19a) (FIG. 8), which forms the leading edge, ensures enhanced fluid cutting properties, providing a major advantage over annular or duct-shaped wings.

The tendency of the fluid to form vortices at the wing tips, known as “induced drag”, is minimized by the duct (16a) created by joining the tip vertices to form a circle.

Having sufficiently described my invention, I consider the contents of the following clauses to be novel and therefore claim the invention as of my sole property:

1. A tubed perfect square wing made up of a perfect square joined by two of the tip vertices thereof such as to define a duct, in which the remaining two vertices are aligned with the longitudinal axis of the wing, the vertices aligned with the longitudinal axis of the wing forming the top portion of the wing, the vertical stabilizers being built into the structure of the wing and forming the rear portion thereof, and the air brake surfaces being built into the inside of the duct.

2. A tubed perfect square wing according to the preceding claim, characterized in that two elements are built into the structure thereof: a control surface, referred to as the vertical stabilizers, and the air brakes.

3. A tubed perfect square wing according to claim 1, characterized in that the inverted form thereof is suitable for use on land as an aerodynamic device, said implementation serving to increase the “ground effect” in high-performance motor vehicles.

4. A tubed perfect square wing for marine or submarine use, specifically but not exclusively installed on a navigation craft or structure, characterized in that propulsion means can be installed inside the duct.

5. A tubed perfect square wing suitable for use as a planar wing tip device for reducing induced drag.
